(19) United States
(12) Patent Application Publication
(10) Pub. No.: US 2009/0244280 A1
(43) Pub. Date: Oct. 1, 2009

(54) DETECTION DEVICE AND METHOD FOR DETECTING FIRES ALONG A MONITORING PATH

(76) Inventors: Thomas Hanses, Feldkirchen-Westerham (DE); Ralph Bergmann, Neubeuern (DE); Ulrich Oppelt, Zorneding (DE); Bernd Siber, Glonn (DE)

Correspondence Address: MICHAEL J. STRIKER, 103 EAST NECK ROAD, HUNTINGTON, NY, 11743, US

(21) Appl. No.: 12/371,779

(22) Filed: Feb. 16, 2009

(30) Foreign Application Priority Data
Mar. 25, 2008 (DE) 102008001380.3

(51) Int. Cl. H04N 7/18; G08B 17/10

(52) U.S. Cl. 348/143; 340/630; 348/E07.085

(57) ABSTRACT

A detection device for detecting fires and/or fire features in a monitoring region along a monitoring path includes a camera device that is located and/or may be located in the monitoring region in order to generate image data, an evaluation device which is designed to detect fire and/or fire features in the monitoring range by evaluating the image data, in the case of which the detection device may be used to select a section of the monitoring range in which the evaluation is carried out, and the detection device is designed such that the monitoring range section has a maximum viewing angle alpha of less than 5°, preferably less than 3°, and, in particular less than 1°.

### CROSS-REFERENCE TO RELATED APPLICATION

The invention described and claimed hereinbelow is also described in German Patent Application DE 10 2008 001 380.3 filed on Apr. 25, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a detection device for detecting fires and/or fire features in a monitoring region along a monitoring path, the detection device including a camera device which is located and/or may be located in the monitoring region in order to generate image data, and including an evaluation device which is designed to detect fire and/or fire features in the monitoring range by evaluating the image data, in the case of which a section of the monitoring range in which the evaluation is carried out is selectable and/or selected using the detection device. T he present invention also relates to a method for detecting fires and/or fire features.

Fire alarm systems include fire alarms as sensor devices for detecting fire, smoke, flames, or other fire features. They are also are used in public buildings such as schools or museums, and in private buildings. The majority of fire alarms may be roughly divided into two groups: a first group relates to point-type fire alarms, such are used, e.g. in offices or children's rooms, i.e. in smaller spaces. Point-type fire alarms are typically installed on the ceiling, and they detect a fire or spreading smoke via optical, thermal, or chemical detection at exactly one point. These fire alarms have the advantage that, e.g. rising smoke that collects below the ceiling is detected very quickly. The disadvantage of these fire alarms is that a plurality of fire alarms must be used in larger spaces, e.g., warehouses, to ensure that the entire area is covered.

An alternative to this is provided by a second group of fire alarms that are designed as video fire-detection devices, in the case of which video monitoring systems are used that record a video image of a monitoring region via commercial monitoring cameras and evaluate it in a monitoring center for the presence of fire or fire features.

DE 10 246 056 A1 discloses smoke alarms which include an image recorder and a light source. This smoke alarm is used, e.g. as a ceiling-mounted smoke alarm, and it is designed such that the focus of the image recorder is adjusted to be situated approximately 10 cm below the housing of the smoke alarm. If the illumination is poor, a light source may be activated which illuminates the focal point. With smoke alarms of this type, since the focus is close, background images are blurry as compared with images taken of the surroundings directly adjacent to the focus.

DE 100 114 11 A1 which represents the closest prior art also relates to a fire alarm that uses a video camera or an infrared camera as the image recorder, the image recorder being adjusted such that a large camera viewing field and a life-like depiction of the observed scene is provided. Fire is detected via object analysis, in which individual objects in the scenes are automatically analyzed, in particular in terms of whether these objects are hidden by smoke, thermal inhomogeneities, or fire, the analysis being carried out by comparing the objects currently being recorded to stored objects.

### SUMMARY OF THE INVENTION

Accordingly, it is an object of the present invention to provide a detection device and a method of detecting fires along a monitoring path, which eliminate the disadvantages of the prior art,

The present invention relates to a detection device that is suited and/or designed to detect fires and/or fire features, in particular signs of fire, and that may also be referred to as a fire alarm or a fire sensor. The detection takes place along a monitoring path; preferably, a monitoring volume formed along the monitoring path is observed.

The detection device includes a camera device that includes, as a sensor field, e.g. a matrix or a linear array of sensor elements that is oriented and/or orientable in such a manner that it detects the monitoring region and/or the monitoring volume along the monitoring path, and that generates image data on the monitoring region during operation. The camera device or sensor element of the camera device may be designed as any type of UV, VIS, and/or NIR camera. In alternative embodiments, the camera device or the sensor element may also be realized as an FIR sensor, a thermal imaging camera, or a thermopile array.

An evaluation device is used to detect the fire and/or fire features and/or signs of fire in the monitoring region by evaluating the image data, preferably using digital image processing. As an alternative, or in addition thereto, it is also feasible to incorporate analogous image-processing steps in the scope of the present invention. The evaluation is also—or preferably exclusively—carried out in a monitoring region section or a plurality of monitoring region sections which is/are selectable, selected, and/or defined by the detection device.

Within the scope of the present invention it is provided that the at least one monitoring region section lies within a maximum viewing angle of the camera device of less than 5°, preferably less than 3°, and in particular less than 1°. The maximum viewing angle is the collection angle of the viewing field of the detection device and/or camera device that is used, in exactly one, a few, or all planes in which a vector of the main observation direction of the camera device is also located. The detection device is designed, in particular, such that the optical resolution in the monitoring region section is sufficiently high to allow the evaluation to be carried out in the evaluation device.

According to a premise of the present invention, it is reasonable in particular for very large, open areas such as spacious indoor enclosures to use the detection device to monitor a monitoring path which extends, e.g. along the entire length of the spacious area. A particular advantage of image-supported monitoring of the monitoring path compared to other linear alarms is the fact that disturbances, e.g. which could be created by vibrations, may be compensated for using suitable image-processing algorithms such as image stabilization. Special design-related or programming adjustments must be made to conventional cameras in order to monitor additional paths, since camera devices that include optics or sensor elements having normal designs do not provide sufficient optical resolution for the observation of distant objects.

It is therefore provided in a preferred embodiment of the present invention for the camera device to include an optics device which limits the detection region of the camera device to the viewing angle. In particular, this object device is designed as a telephoto lens or a zoom lens. Using an optics device of this type, it is possible to design the monitoring region section to be sufficiently large on the sensor element.

As an alternative or in addition thereto, a high-resolution sensor element is used, in the case of which the program of the evaluation device is designed to limit the detection range of the sensor element and, therefore, to limit the camera device to the desired maximum viewing angle. The advantage of this embodiment is that an expensive optical device is not required, although the additional costs for a high-resolution sensor element do not make as much of a difference these days.

The detection device is preferably oriented so that it may monitor the monitoring path across a distance of at least 10 m, in particular of at least 15 m, and most particularly of at least 20 m. It is also preferable for the camera device to be adjusted to provide sharp image resolution at the selected maximum distance, so that fires and/or fire features may be detected at the maximum distance. It should also be possible to monitor the entire monitoring path or at least a majority of the monitoring path. It is therefore also preferable when the depth of field from the maximum distance extends to less than 5 m, preferably to less than 3, and in particular to less than 1 m toward the camera device. Optionally, the monitoring path is designed to have one or more folds, it being preferably provided that at least one fold is located at a distance of at least 1 m, and preferably of at least 3 m from the camera device. A “fold” is understood to be a redirection or deflection of the monitoring path, e.g. by a mirror.

It is preferably provided that detection is carried out with reference to or based on abstract features, e.g. texture, structure, color, intensity, etc., in the image data of an object shown in the monitoring region section or of a related structure. Fires and/or fire features are detected via optical emissions such as heat or fire, via particle emissions, such as thick smoke or fumes, or via thermal inhomogeneities, which result in a change in the abstract features in the image data of the monitoring region section. For this type of evaluation, it is therefore necessary for the object or the structure in the monitoring region section to be depicted with sharp image resolution.

It is basically possible for the evaluation device to detect fires and/or fire characteristics by evaluating an object or an appropriate structure that is situated in the monitoring region section. In particular, the evaluation may be carried out based on a structure which is already present in the monitoring environment, or on a stationary object, such as a door, a window, or a cabinet.

In a development of the present invention, a detection device is provided that is characterized by the fact that the detection device includes a marking device which is designed to generate or depict a marking in the monitoring region section.

Instead of using a passive marking, i.e. a marking which is already present in the environment without any additional measures, it is also possible to actively apply or add a marking in the monitoring region section. This actively applied marking has the advantage that its structure is known in advance and/or may be tailored to the intended use.

In a preferred design, the marking device is designed as an optical marking, in particular as a target plate. The optical marking may include geometric figures, elements marked in color, and/or other structures that are preferably designed such that the detection of fires and/or fire features is simplified.

In an alternative embodiment or development, the marking device includes an illumination source, or it is designed as an illumination source, the illumination source being designed to project a marking and/or the optical marking in the monitoring region section and/or to illuminate the optical marking. It may be provided that the illumination source is integrated at or in the camera device, so that the device is preferably one device which can be installed as a whole. As an alternative, the illumination source is located in or adjacent to the monitoring region section, so that the distance between the illumination source and the monitoring region section or the marking is small, e.g. less than 3 m, and preferably less than 2 m.

According Lo the idea of the present invention which is to monitor an extended linear monitoring path using the detection device, it is provided that the camera device and the marking are separated by at least 10 m, in particular by at least 15 m, and particularly preferably by at least 20 m. The marking performs the function of a transmitter, and the camera device serves as the receiver. In refinements of the present invention, the detection device may also be designed such that larger distances are monitored, e.g. distances greater than 50 m or greater than 100 m.

A further advantage of the present invention may be attained by supplying the data and power to the detection device, in particular to the camera device and/or the marking device, via a common two-wire line or four-wire line. This is designed as a field bus in particular. This embodiment of the present invention utilizes the advantage of the detection device that it requires only minimal power consumption.

In an embodiment of the evaluation device, interferences in the viewing region of the camera device in the region of the monitoring path, which can occur due, e.g. to cranes, birds, etc., are masked out. This may be carried out, e.g. using an object-tracking mechanism, in the case of which an interfering object is detected and tracked. This embodiment ensures that no false alarms are triggered, or that the number of false alarms is minimized.

A further subject of the present invention relates to a method for detecting fires and/or fire features, in particular along a monitoring path, having the features of claim 10. In this method, a detection device according to one of the preceding claims, or a detection device as described above is used. In a first step in the method, a marking is positioned, selected, and/or formed in front of a camera device, the distance between the camera device and the marking amounting to at least 10 m, preferably at least 15 m, and particularly preferably at least 20 m. In a second step, fires and/or signs of fire are detected in the region of the marking by evaluating the image data that were recorded by the camera device. The detection is preferably carried out using digital image-processing algorithms. As an alternative or in addition thereto, it is also possible to use analog image-processing steps.

In a preferred development of the present invention, the detection device includes an illumination source which generates and/or illuminates the marking, the illumination device preferably being activated only temporarily, e.g. when lighting conditions are poor.

### BRIEF DESCRIPTION OF THE DRAWINGS

FIG. 1 shows a greatly schematicized depiction of a detection device for creating a measurement path along a linear monitoring path, as an embodiment of the present invention.

### DESCRIPTION OF THE PREFERRED EMBODIMENTS

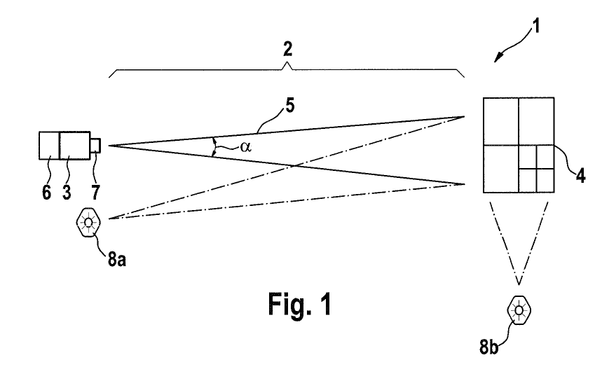

FIG. 1 shows, in a greatly schematicized depiction, a detection device 1 for creating a monitoring path 2 using a camera device 3. Measurement path 2 is designed as an extended, linear monitoring path 2 which is at least 10 m in length, preferably at least 15 m in length, and is particularly preferably at least 20 m in length. Detection device 1 is designed to detect fires or fire features along monitoring path 2, and it is used, e.g. in spacious indoor enclosures, train stations, or other spacious areas. Camera device 3 is positioned at the beginning of a monitoring path 2.

Camera device 3 is pointed toward a marking 4 which is located at the end of the measurement path. Marking 4 performs the role of being a signal transmitter, and camera device 3 functions as a signal receiver. Monitoring path 2 is used as a transmission path which changes signals formed by marking 4 depending on the ambient conditions. Marking 4 is designed to be small as compared to the length of monitoring path 2, and has a maximum diameter, e.g. of less than 1 m, and preferably less than 0.5 m. Via the length of measurement path 2 and the maximum diameter of marking 4, a usable viewing field 5 of camera device 3 is defined that limits a volume which is monitored along monitoring path 2 and which is monitored using camera device 3. To attain an adequate certainty of detection, it is preferrable for the depth of field starting from marking 4 to extend as far as possible in the direction of camera device 3, e.g. to within 2 m or 1 m in front of camera device 3. This wide depth of field may be ensured, e.g. by using suitable stops in camera device 3.

To evaluate the image data recorded by camera device 3 in viewing field 5, detection device 1 includes an evaluation unit 6 which is designed, e.g. as a digital computer unit. Evaluation unit 6 may be integrated in the same housing with camera device 3, or, as an alternative, evaluation unit 6 may be positioned at a distance from camera device 3, the image data of camera device 3 being transmitted to evaluation device 6 in a wireless manner or via cables.

According to the measurement principle of detection device 1, abstract features of marking 4, i.e. structures, lines, colors, and/or intensities, are preferably recorded and evaluated by camera device 3. When a fire occurs, the image of marking 4 changes; the image is changed by fire features, e.g. thermal inhomogeneities, the formation of fumes or thick smoke, or the emission of flames or heat. It does not matter whether the fire has broken out in the direct vicinity of marking 4, since the change to the image of marking 4 also occurs when the fire features occur in the region of monitoring path 2, or, as considered from a control perspective, if they act on the monitoring path.

When changes of this type occur, detection device 1 emits an information signal, i.e. a fire alarm. As an option, current image data may be output, e.g. to a monitoring center, for verification purposes.

Since monitoring path 2 is very long, it is necessary to design camera device 3 such that it has an adequate depth of field, and so that the image of marking 4 has adequate optical resolution. In a first alternative of the embodiment, the camera device includes a telephoto or zoom lens 7 which reduces the viewing angle alpha of viewing field 5 to a value of less than 5°, preferably less than 3°, and particularly preferably less than 1°. As an alternative or in addition thereto, camera device 3 may include a high-resolution sensor element (megapixel camera), the limitation of the detection range of camera device 3 on viewing field 5 being carried out by a program. Simply, only the region of the sensor element which shows marking 4 is evaluated.

Another advantage of the measurement method is that interferences, e.g. caused by moving objects such as cranes in a spacious indoor enclosure, may be masked out using suitable programming. The susceptibility of the measurement method to interference is also minimal, since interferences with regard for the position of marking 4 caused, e.g. by vibrations, may be compensated for using image-processing methods, e.g. a correction for shaking.

Camera device 3 and evaluation device 6 may be designed, e.g. as an embedded hardware solution, and it may be manufactured at low cost, since inexpensive camera modules are available. In addition, detection device 1 has only minimal current consumption, thereby making it possible, as an option, to connect camera device 3 or evaluation device 6 to a two-wire field bus, thereby enabling data transmission and power supply to take place simultaneously.

In a first possible embodiment of the present invention, marking 4 is designed as an element that is present in the monitoring environment. For instance, cabinets, door openings, or other characteristic features in the monitoring area may be used. As an option, marking 4—regardless of which embodiment is used—may be illuminated using illumination sources 8a and/or 8b, e.g. so that detection may also be carried out at night or in poor lighting conditions. Illumination source 8a is positioned on camera device 3, and illumination source 8b is positioned in the region of marking 4. When light source 8a is positioned in the region of or in the housing of camera device 3, this has the advantage that only camera device 3 with light source 8a may be connected in terms of providing a signal and obtaining power, but marking 4 does not require any connections. The use of light source 8b has the advantage that it is located in the immediate vicinity, e.g. at a distance of less than 5 m, preferably less than 3 m, and particularly preferably less than 1 m away from marking 4, so the light output required is very low.

In a further embodiment of the present invention, marking 4 is designed as a target plate or a target marking which includes, e.g. elements with geometric or color markings. The target plate may be adapted to the requirements of the evaluation by evaluation device 6.

As a further possibility, marking 4 may be realized as a light pattern which is generated by light source 8a or 8b. A light pattern of this type may also be designed, e.g. to vary over time. It is also feasible, of course, for the various possibilities to be combined with each other, e.g. to project a light pattern onto a target plate.

To further reduce the current consumption, camera device 3 and/or illumination sources 8a or 8b may be switched on only in intervals, e.g. with a frequency of less than 15 Hz. It is also possible to design illumination sources 8a, b as infrared light sources which emit light outside of the visible range, so that the illumination is invisible to the human eye. Camera device 3 is adapted—in terms of spectral sensitivity—to the wavelengths of illumination sources 8a, b.

It will be understood that each of the elements described above, or two or more together, may also find a useful application in other types of constructions and methods differing from the types described above.

While the invention has been illustrated and described as embodied in a detection device and method for detecting fires along a monitoring path, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A detection device for detecting fires and/or fire features in a monitoring region along a monitoring path, comprising a camera device locatable in a monitoring region in order to generate image data; and an evaluation device configured to detect fire and/or fire features in a monitoring range by evaluating the image data, so that a section of the monitoring range in which the evaluation is carried out is selectable using the detection device, wherein the detection device is configured such that the monitoring range section has a maximum viewing angle in at least one plane of a viewing field of the detection device and/or the camera device of less than 5°.

2. The detection device as defined in claim 1, wherein the detection device is configured so that the monitoring range section has a maximum viewing angle in at least one plane of the viewing field of the detection device and/or camera device of less than 3°.

3. The detection device as defined in claim 1, wherein the detection device is configured so that the monitoring range section has a maximum viewing angle in at least one plane of the viewing field of the detection device and/or camera device of less than 1°.

4. The detection device as defined in claim 1, wherein said camera device includes an optics device which limits the detection range of said camera device to the maximum viewing angle.

5. The detection device as defined in claim 1, wherein said evaluation device is programmed to limit the detection range of said camera device to the maximum viewing angle.

6. The detection device as defined in claim 1, wherein the camera device includes an optics device which limits the detection angle of the camera device to the maxi mum viewing angle, and the evaluation device is programmed to limit the detection range of the camera device to the maximum viewing angle.

7. The detection device as defined in claim 1, wherein said camera device is adjusted to provide sharp image resolution at a distance of at least 10 m.

8. The detection device as defined in claim 7, wherein said camera device is adjusted to provide sharp image resolution at a distance of at least 15 m.

9. The detection device as defined in claim 7, wherein said camera device is adjusted to provide sharp image resolution at a distance of at least 20 m.

10. The detection device as defined in claim 1, further comprising a marking device which is configured to provide a marking in the monitoring range section in a way selected from the group consisting of generating the marking, depicting the marking, and both.

11. The detection device as defined in claim 10, wherein said marking device is configured as an optical marking.

12. A detection device as defined in claim 11, wherein said marking device is configured as the optical marking selected from the group consisting of the optical marking having geometric figures, the optical marking having elements which are marked in color, and both.

13. A detection device as defined in claim 11, wherein said marking device is configured as a marking device selected from the group consisting an illumination source, including an illumination device, and both, configured to act on the marking in a way selected from the group consisting of projecting the marking in the monitoring region section, illuminating the marking, and both.

14. A detection device as defined in claim 13, wherein said illumination source is configured as the illumination source selected from the group consisting of located in said camera device, integrated in said camera device, located in the monitoring region section, and combinations thereof.

15. A detection device as defined in claim 10, wherein said camera device and said marking are separated by at least 10 m.

16. A detection device as defined in claim 15, wherein said camera device and said marking are separated by at least 15 m.

17. A detection device as defined in claim 15, wherein said camera device and said marking are separated by at least 20 m.

18. A detection device as defined in claim 1, further comprising an interface for connecting a line selected from the group consisting of a two-wire line and a four-wire line, to provide a supply selected from the group consisting of a supply of power, a supply of data, and both, to said detection device.

19. A method for detecting fires and/or fire features includes using the detection device as defined in claim 1.

20. A method for detecting fires and/or fire features as defined in claim 19, wherein said using including in a first step positioning a marking and/or selecting a marking by a camera device, separating the camera device and a marking by a distance of at least 10 m; and in a second step detecting by an evaluation device fires and/or signs of fires by evaluating image data of the marking.

21. A method for detecting fires and/or fire features as defined in claim 20, wherein said distance is at least 15 m.

22. A method for detecting fires and/or fire features as defined in claim 20, wherein said distance is at least 20 m.

23. A method for detecting fires and/or fire features as defined in claim 19, further comprising using at least one illumination source for a step including generating a marking, illuminating a marking, and both.

24. A method for detecting fires and/or fire features as defined in claim 23, further comprising activating the illumination source only temporarily.

25. A method for detecting fires and/or fire features as defined in claim 24, wherein said activating the illumination source includes activating the illumination source only temporarily when lighting conditions are poor.
